(19) United States
(12) Patent Application Publication
(10) Pub. No.: US 2003/0014141 A1
(43) Pub. Date: Jan. 16, 2003

(54) Method and system for immediately issuing production plan

(76) Inventor: Po-Wen Lu, Taipei (TW)

Correspondence Address: SAWYER LAW GROUP LLP, P.O. Box 51418, Palo Alto, CA, 94303, US

(21) Appl. No.: 09/973,154

(22) Filed: Oct. 9, 2001

(30) Foreign Application Priority Data
Jul. 11, 2001 (TW) 90116932

(51) Int. Cl. G06F 19/00; G06F 17/60

(52) U.S. Cl. 700/100; 700/101; 705/8; 705/27; 705/28; 705/7

(57) ABSTRACT

A method and a system for immediately issuing a production plan are proposed, in which a production plan is transmitted by a network to a production-line host, so as to allow the production-line host to access the production plan and allow a production-associated department to monitor an operational status in production in real time. First, the production plan is transmitted through the network to a first database for storage, allowing the production-line host to access the production plan for performing the production. Moreover, the production-line host transmits the operational status in the production to a second database for storage, allowing the production-associated department to read the operational status for monitoring the production in real time. In addition, material data stored in the first and second databases are integrated by the system to be used as a material stock reference for next production.

### FIELD OF THE INVENTION

The present invention related to methods and systems for immediately issuing production plans, and more particularly, to a method and a system for immediately issuing a production plan, in which a production plan can be updated and issued in real time through a network interface by a marketing department, so as to allow a production line to access the production plan by using a browser and effectively control an operational status in production.

### BACKGROUND OF THE INVENTION

Conventionally, a production plan is generally constructed in a meeting through collaboration of personnel from associated departments, and recorded on a whiteboard to be made a copy issued to a production line, which follows the production plan for executing production.

However, the conventional method for issuing the production plan as above is rather time-ineffective and labor-consuming. Moreover, the associated departments need to be respectively informed if any modification is made to the production plan. This is liable to cause an error or delay in the production. Furthermore, as the conventional method is merely used to issuing the production plan to the production line, any abnormal condition occurred in the production can not be immediately detected and eliminated, thereby making the production reduced in efficiency and an operational status in the production not able to be effectively monitored.

Therefore, it is desired to develop a method for immediately issuing a production plan and effectively monitoring an operational status in production.

### SUMMARY OF THE INVENTION

A primary objective of the present invention is to provide a method and a system for immediately issuing a production plan, so as to allow a newly updated production plan to be issued to a production line in real time for preventing delay in production from occurrence, and to allow an operational status in the production to be effectively monitored for immediately detecting and eliminating any abnormal condition occurred in the production.

According to the above and other objectives, the present invention proposes a method and a system for immediately issuing a production plan, in which a production plan is transmitted by a network to a production-line host, so as to allow the production-line host to access the production plan and allow a production-associated department to monitor an operational status in production in real time. The method for immediately issuing a production plan comprises the steps of: (1) transmitting the production plan through the network to a first database for storage; (2) reading the production plan stored in the first database via the production-line host through a network connection to the system for immediately issuing a production plan, so as to perform the production according to the production plan; (3) transmitting the operational status in the production via the production-line host through the network to a second database for storage; (4) reading the operational status in the production stored in the second database via the production-associated department through the network connection to the system, so as to monitor the production in real time; and (5) integrating via the system material data stored in the first database prior to performing the production with those stored in the second database after performing the production, and storing the integrated data in the first database to be used as a material stock reference for next production.

The system for immediately issuing a production plan comprises: a first receiving module for receiving and transmitting the production plan to the production-line host; a first database for storing the production plan received by the first receiving module therein, so as to allow the production-line host to read the production plan and perform the production according to the production plan; a second receiving module for receiving the operational status in the production transmitted from the production-line host; a second database for storing the operational status in the production received by the second receiving module therein, so as to allow the production-associated department to read and monitor the operational status in the production; a retrieving/informing module for reading the operational status in the production stored in the second database and transmitting the operational status to the production-associated department, which submits a request for inquiring the operational status, and for automatically informing the production-associated department of a message generated by the production-line host for showing an abnormal condition occurring in the production; and a processing module for integrating material data stored in the first database prior to performing the production with those stored in the second database after performing the production, and storing the integrated data in the first database to be used as a material stock reference for next production.

### BRIEF DESCRIPTION OF THE DRAWINGS

The present invention may best be understood through the following description with reference to the accompanying drawings, in which:

FIG. 1 is a schematic diagram showing a connection relationship between a user's host and the system for immediately issuing a production plan of the invention;

FIG. 2 is a block diagram showing system architecture of the system for immediately issuing a production plan of the invention;

FIG. 3 is a schematic diagram showing the steps involved in performing the method for immediately issuing a production plan of the invention;

FIG. 4 is a schematic diagram showing the steps involved in performing another embodiment of the method for immediately issuing a production plan of the invention;

FIG. 5 is a schematic diagram showing the steps involved in performing a further embodiment of the method for immediately issuing a production plan of the invention; and

FIGS. 6(A) and 6(B) are schematic diagrams respectively showing a picture displayed on a browser in the use of the method and system for immediately issuing a production plan of the invention.

### DETAILED DESCRIPTION OF THE PREFERRED EMBODIMENT

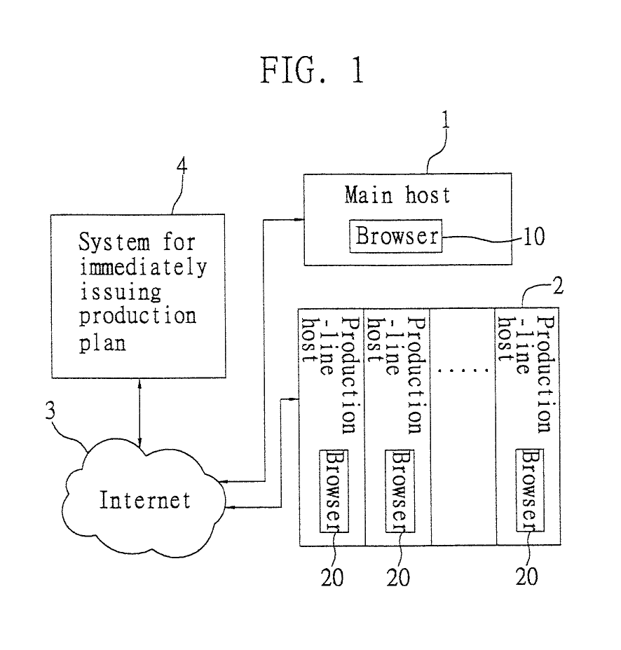

FIG. 1 illustrates a connection relationship between a user's host and the system for immediately issuing a production plan of the invention. As shown in the drawing, a main host 1 and a plurality of production-line hosts 2 are respectively connected to the system for immediately issuing a production plan 4 of the invention by internet 3. The main host 1 allows a production plan to be inputted through a network interface such as a browser 10 and the internet 3 to the system for immediately issuing a production plan 4 of the invention. Similarly, each of the production-line hosts 2 can login the system for immediately issuing a production plan 4 through the internet 3 and access the production plan, which is displayed on a browser 20 of the production-line host 2, wherein the production-line host 2 includes various production lines, such as manufacturing production line, packing production line and so on. In this case, when any modification is made to the production plan, there is no need to notify each associated department of the modified production plan by using a telephone call or a written document; instead, the modified production plan is available in the digital form of information for each associated department through the system for immediately issuing a production plan 4, so that expenses in time and manpower can be reduced.

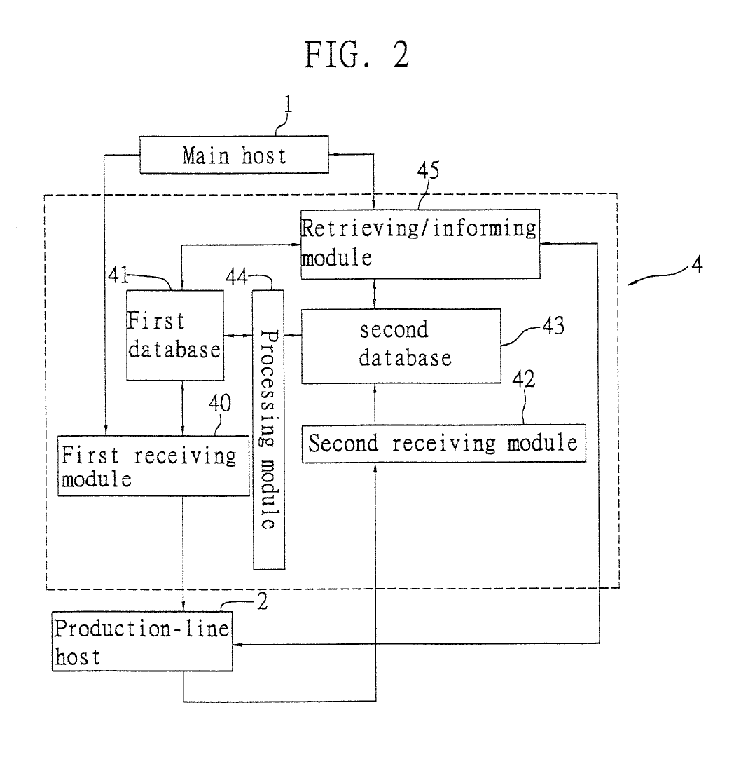

FIG. 2 illustrates system architecture of the system for immediately issuing a production plan of the invention. As described above, a main host 1 is used to transmit a production plan to the system for immediately issuing a production plan 4 of the invention for allowing each production-line host 2 to obtain the production plan in real time. As shown in the drawing, the system for immediately issuing a production plan 4 includes a first receiving module 40, a first database 41, a second receiving module 42, a second database 43, a processing module 44 and a inquiring/informing module 45.

The first receiving module 40 is used to receive the production plan issued from the main host 1 and then forward the production plan to the production-line host 2. Therefore, if the production plan is processed for updating or modification, the newly processed production plan can be transmitted to the production-line host 2 by the browser 10 and accessed by the production-line host 2 through its browser 20 (not shown). The first database 41 is used to store the production plan received by the first receiving module 40. The second receiving module 42 receives information of an operation status in production transmitted from the production-line host 2, wherein the operational status reflects condition of the production performed by production lines in the production-line host 2 following the production plan, such as packing production line, manufacturing production line and so on. The second database 43 is used to store the operational status received by the second receiving module 42. The processing module 44 functions in integrating material data in the production plan stored in the first database 41 prior to executing the production with material data in the operational status stored in the second database 43 after performing the production, and storing the integrated material data in the first database 41, wherein the integrated material data can be used as material stock reference in the production. The retrieving/informing module 45 is used to retrieve the operational status of a production line from the second database 43 as requested by an associated department, and transmit the retrieved operational status to the associated department. Moreover, when a message is generated for an abnormal condition occurring in the production line, the retrieving/informing module 45 can automatically inform an associated department of the message, so as to help solve the abnormal condition instantly.

In addition, the system for immediately issuing a production plan 4 sets a predetermined time, for allowing the material data in the first database 41 prior to executing the production to be balanced off by the material data in the second database 43 after performing the production by using the processing module 44 at the predetermined time, e.g. at 2 a.m. on each day next to the production day.

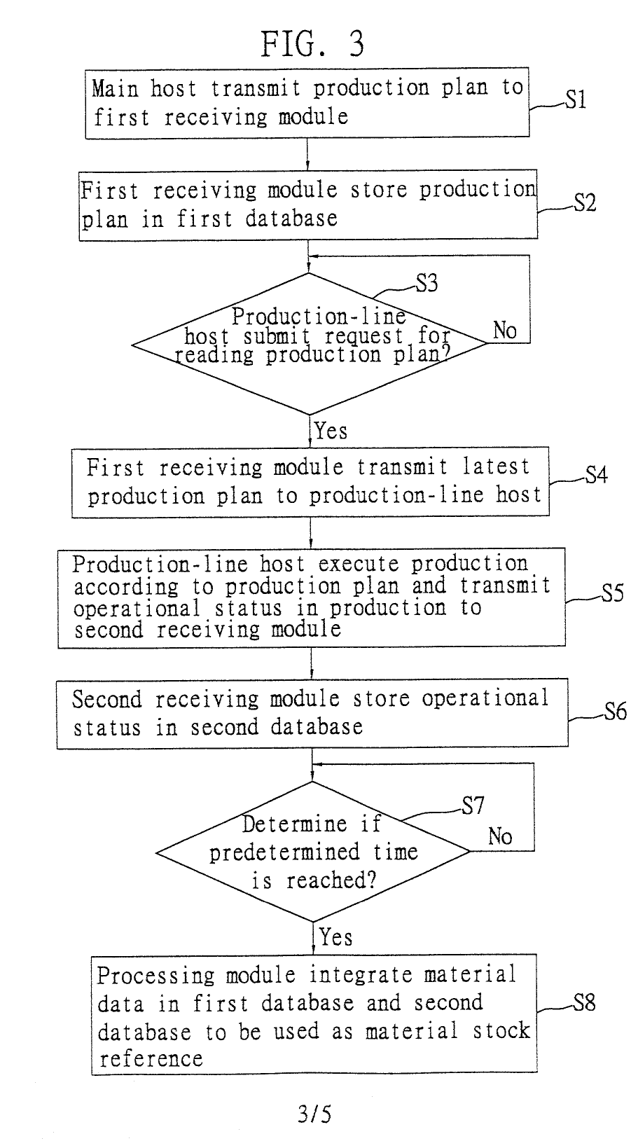

FIG. 3 illustrates the steps involved in performing the method for immediately issuing a production plan of the invention. In the following, the method for immediately issuing a production plan of the invention is depicted with reference to FIGS. 2 and 3.

In the method for immediately issuing a production plan of this embodiment, a main host 1 is connected to a production-line host 2 via a network. First in step SI, the main host 1 is inputted with a production plan to be transmitted to the first receiving module 40 of the system for immediately issuing a production plan 4. Thereafter, step S2 is followed.

In step S2, after receiving the production plan, the first receiving module 40 stores the received production plan in the first database 41. Thereafter, step S3 is followed.

In step S3, the system for immediately issuing a production plan 4 determines if the production-line host 2 submits a request for reading the production plan. If the request is submitted, then step S4 followed, or else the step S3 is repeated.

In step S4, the first receiving module 40 retrieves the latest production plan from the first database 41, and transmits the latest production plan to the production-line host 2 that submits the request. Thereafter, step S5 is followed.

In step S5, the production-line host performs production according to the transmitted production plan and automatically transmits an operational status in the production to the second receiving module 42. Thereafter, step S6 is followed.

In step S6, after receiving the operational status, the second receiving module 42 stores the received operational status in the second database 43. Thereafter, step S7 is followed.

In step S7, the system for immediately issuing a production plan 4 determines if a predetermined time set therein is reached. If the predetermined time is reached, then step S8 is followed, or else the step S7 is repeated.

In step S8, the processing module 44 integrates material data stored in the first database 41 and the second database 43 in a manner that the material data in the first database 41 is balanced off by the material data in the second database 43, and stores the integrated material data in the first database 41 to be used as material stock reference in the production.

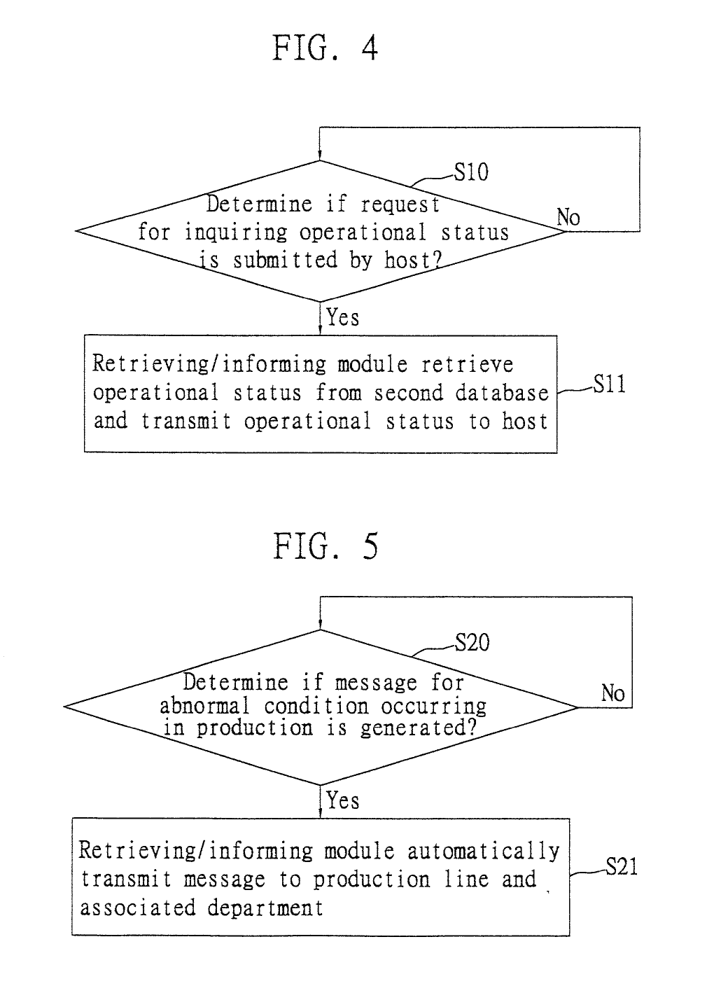

FIG. 4 illustrates the steps involved in performing another embodiment of the method for immediately issuing a production plan of the invention, where this embodiment is performed after completing the step S6 in FIG. 3.

First in step S10, the system for immediately issuing a production plan 4 determines if a host submits a request for inquiring the operational status in the production. If the request is submitted, then step S11 is followed, or else, the step S10 is repeated.

In step S11, the retrieving/informing module 45 retrieves the operational status from the second database 43 and transmits the same to the host that submits the request, wherein the host can be a production-line host or a host of an associated department, so as to allow the operational status in the production to be effectively monitored.

FIG. 5 illustrates the steps involved in performing a further embodiment of the method for immediately issuing a production plan of the invention, wherein this embodiment is performed during the step S5 in FIG. 3.

First in step S20, the system for immediately issuing a production plan 4 determines if a message is generated for an abnormal condition occurring in the production. If the message is generated, then step S21 is followed, or else, the step S20 is repeated.

In step 21, the retrieving/informing module 45 automatically transmits the message to a production line or an associated department, so as to help solve the abnormal condition instantly.

In conclusion, in the use of the system for immediately issuing a production plan 4 of the invention, a latest production plan can be immediately transmitted to production lines through a network connection and a browser interface. This can therefore avoid a manufacturing delay due to inefficient transmission and significantly reduce expenses in time and manpower required for production. Furthermore, since an operational status in the production is stored in the second database 43 in real time, for allowing an associated department to immediately monitor the operational status if necessary. This therefore helps solve an abnormal condition if occurring in a production line instantly and allows the production operation to be easily controlled between different production lines.

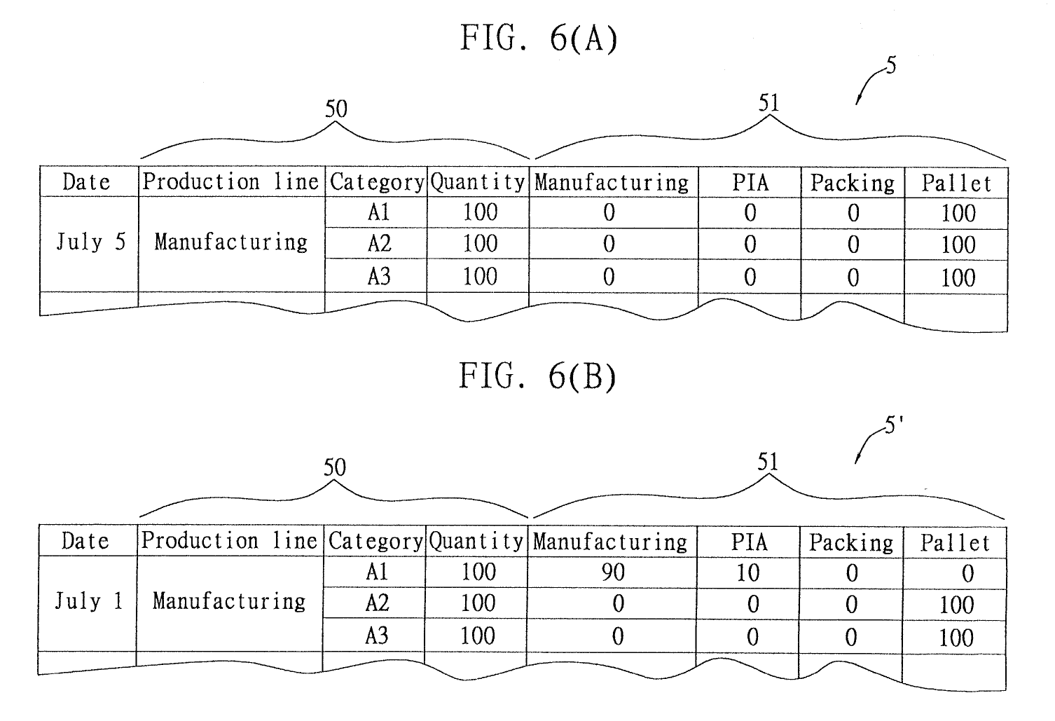

In addition, the system for immediately issuing a production plan 4 of the invention can set a predetermined time, which is used to allow the processing module 44 to integrate material data stored in the first database 41 and the second database 43 in a manner that the material data in the first database 41 is balanced off by those in the second database 43, and to store the integrated material data in the first database 41. As shown in FIGS. 6(A) and 6(B), pictures 5, 5′ displayed on a browser are used to inform a production-related department of correlation between production plan data 50 and an operational status 51 of a production line. If number in a pallet column is equal to that in a quantity column of the production plan data 50, it indicates the production line completes production of a certain product category. For example, as shown in FIG. 6(A), the number in the pallet column “100” represents a quantity of manufactured products in stock. If the number in the pallet column is not equal to that in the quantity column, the difference in number between the pallet column and the quantity number represents a quantity of inferior products in stock. As shown in FIG. 6(B), for manufacturing a product category A1 in a quantity of 100 by using a manufacturing production line, 90 in a manufacturing column represents the quantity of A1 category not completely processed by the manufacturing production line, while 10 in a PIA column indicates the quantity of A1 category completely processed by the manufacturing production line (i.e. the quantity of semi-manufactured products in stock), wherein the semi-manufactured products are subjected to a subsequent process performed by a PIA production line. This therefore makes materials or products in stock available for the production line, and helps eliminate the problem of delay in production due to uncertainty in material quantity, so that the operational status in the production can be monitored in real time, and a problem occurring in the production line can be solved instantly. For example, the processing module 44 can assign the task of a production line with a problem in production to another production line for continuing the production, and store production data in the first database 41.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for immediately issuing a production plan, for use with a system for immediately issuing a production plan, wherein a production plan is transmitted to the system by a network for allowing a production-line host to access the production plan and allowing a production-associated department to monitor an operational status in production in real time; the method comprising the steps of:
a. transmitting the production plan through the network to the system;
b. storing the production plan received by the system in a first database;
c. reading the production plan stored in the first database via the production-line host through a network connection to the system, so as to perform the production according to the production plan;
d. transmitting the operational status in the production via the production-line host through the network to a second database for storage;
e. reading the operational status in the production stored in the second database via the production-associated department through the network connection to the system, so as to monitor the production in real time; and
f. integrating via the system material data stored in the first database prior to performing the production with those stored in the second database after performing the production, and storing the integrated data in the first database to be used as a material stock reference for next production.

2. The method of claim 1, wherein after performing the step (6), the integrated data stored in the first database include data relating to well-manufactured products and inferior products in stock.

3. The method of claim 1, after performing the step (c), further comprising the steps of:
(c-1) determining via the system if a message is generated for an abnormal condition occurring in the production, wherein if the message is generated, step (3-2) is followed, or else, the step (3-1) is repeated; and
(c-2) transmitting automatically the message via the system to the production-associated department.

4. A method for immediately issuing a production plan, for use with a system for immediately issuing a production plan, wherein a production plan is transmitted to the system by a network for allowing a production-line host to access the production plan; the method comprising the steps of:
(a) transmitting the production plan through the network to the system;
(b) storing the production plan received by the system in a first database; and
(c) reading the production plan stored in the first database via the production-line host through a network connection to the system, so as to perform production according to the production plan.

5. The method of claim 4, after performing the step (c), further comprising the steps of: (c-1 determining via the system if a message is generated for an abnormal condition occurring in the production, wherein if the message is generated, step (c-2) is followed, or else, the step (c-1) is repeated; and
transmitting automatically the message via the system to a production-associated department.

6. The method of claim 4, wherein the production-associated department is allowed to monitor an operational status in production in real time, and after performing the step (c), the method further comprises the steps of:
(c-1) transmitting the operational status in the production via the production-line host through the network to a second database for storage;
(c-2) reading the operational status in the production stored in the second database via the production-associated department through the network connection to the system, so as to monitor the production in real time; and
(c-3)integrating via the system material data stored in the first database prior to performing the production with those stored in the second database after performing the production, and storing the integrated data in the first database to be used as a material stock reference for next production.

7. The method of claim 6, wherein after performing the step (c-3), the integrated data stored in the first database include data relating to well-manufactured products and inferior products in stock.

8. The method of claim 3, wherein the system for immediately issuing a production plan comprises:
the first database;
a first receiving module for receiving and storing the production plan in the first database as set forth in the step (a);
the second database;
a second receiving module for receiving and storing the operational status in the production in the second database as set forth in the step (d);
a retrieving/informing module for reading the operational status in the production stored in the second database as set forth in the step (c); and
a processing module for integrating the material data as set forth in the step (f).

9. The method of claim 8, wherein the retrieving/informing module performs the step (c-2) for automatically transmitting the message to the production-associated department according to a determined result from the step (c-1).

10. The method of claim 4, wherein the system for immediately issuing a production plan comprises:
the first database; and
a receiving module for receiving and storing the production plan in the first database as set forth in the step (a).

11. The method of claim 6, wherein the system for immediately issuing a production plan comprises:
the first database;
a first receiving module for receiving and storing the production plan in the first database as set forth in the step (a);
the second database;
a second receiving module for receiving and storing the operational status in the production in the second database as set forth in the step (c-1);
a retrieving/informing module for reading the operational status in the production stored in the second database as set forth in the step (c-2); and
a processing module for integrating the material data as set forth in the step (c-3).

12. A system for immediately issuing a production plan, used for transmitting a production plan through a network to a production-line host, so as to allow the production-line host to access the production plan and allow a production-associated department to monitor an operational status in production in real time; the system comprising:
a first receiving module for receiving and transmitting the production plan to the production-line host;
a first database for storing the production plan received by the first receiving module therein, so as to allow the production-line host to read the production plan and perform the production according to the production plan;
a second receiving module for receiving the operational status in the production transmitted from the production-line host; and
a second database for storing the operational status in the production received by the second receiving module therein, so as to allow the production-associated department to read and monitor the operational status in the production.

13. The system of claim 12, further comprising a retrieving module for reading the operational status in the production stored in the second database and transmitting the operational status to the production-associated department, which submits a request for inquiring the operational status.

14. The system of claim 12, further comprising a informing module for automatically informing the production-associated department of a message generated by the production-line host for showing an abnormal condition occurring in the production.

15. The system of claim 12, further comprising a processing module for integrating material data stored in the first database prior to performing the production with those stored in the second database after performing the production, and storing the integrated data in the first database to be used as a material stock reference for next production.

16. The system of claim 15, wherein the integrated data stored in the first database include data relating to well-manufactured products and inferior products in stock.
